(19) United States
(12) Patent Application Publication
(10) Pub. No.: US 2006/0198380 A1
(43) Pub. Date: Sep. 7, 2006

(54) Apparatus and method for providing fiber to the home

(75) Inventor: Gerald Lee Sharp, Spanish Fort, AL (US)

Correspondence Address: BINGHAM MCCUTCHEN LLP, 3000 K STREET, NW, BOX IP, WASHINGTON, DC, 20007, US

(73) Assignee: iTown Communications, Inc.

(21) Appl. No.: 11/069,955

(22) Filed: Mar. 3, 2005

(51) Int. Cl. H04L 12/56; H04L 12/28

(52) U.S. Cl. 370/400

(57) ABSTRACT

A local community is provided access to a network served by strands of fiber that are routed in a common ribbon or cable sheath. The strands are cut, however, so that there is not a continuous optical path along a fiber strand from the beginning to the end of the cable. Instead, the cut ends of the fiber are each routed to separate customer premises. In this manner, a single cable or ribbon of fiber strands reaches twice as many customer premises. Network access is provided to customers by connecting access equipment, such as switching equipment, to the beginning and ending sides of the fiber ribbon or cable, so that network access is provided to both sides of the cut fiber strands.

### FIELD OF THE INVENTION

The present invention relates to the provisioning of a broadband service in local communities by providing fiber to the home. In particular, according to the present invention, fiber optic cables are routed in rings which are strategically broken to cut the fiber cost in half.

### BACKGROUND OF THE INVENTION

With the advent of and increasing penetration of the Internet, information and communications have become increasingly accessible and important. The Internet has been delivered to homes, conventionally, through telephone networks and cable television networks. Both telephone and cable television networks are capable of providing relatively high bandwidth Internet access to individuals in their homes. Telephone networks provide high bandwidth network access through, for example, digital subscriber line (DSL) service running over copper telephone wires that do not exceed a maximum distance. Some cable television networks provide high bandwidth network access by multiplexing signals on coaxial cable.

Access to the Internet, however, has failed to achieve high penetration rates in individual homes in rural areas. This is because of the high cost to build out networks that reach large numbers of homes in areas of low population density. In the case of telephone networks, the cost to provide DSL in rural areas is high because only a low percentage of homes are close enough to the central office to be served by DSL equipment installed in the central office. To increase penetration rates in rural areas, DSL equipment has to be installed outside of the central office within a certain distance of surrounding homes. This requirement creates large infrastructure costs when the population density is low, which has stifled the deployment of DSL in rural areas.

Cable television networks are similarly expensive to install. Telephone and cable networks have a further disadvantage in that they are proprietary networks, each tend to be bandwidth limited and were designed primarily to provide telephone and television service, respectively, to customers. In particular, both DSL and cable networks tend to allow higher downstream bandwidth than upstream bandwidth.

Fiber optic networks are capable of supporting high bandwidths over relatively long routes. Routing fiber to individual homes has recently begun and this offers the promise of providing broadband network access to customers for telephone, television and other bandwidth intensive applications. In addition, because of the high capacity of optical fibers, fiber to the home networks may be configured to carry information of many different types, including data from present day proprietary networks, such as the telephone and cable networks. Thus, a fiber to the home network may be able to provide open access to proprietary networks and the Internet and bring to end users in rural communities a full spectrum of communications services.

A problem with routing fiber to the home is that the fiber optic cable itself is expensive and expensive to install. Thus, the cost of building a fiber to the home network in rural areas may outweigh the economic benefits of building out the fiber to the home network, notwithstanding all of the technical benefits. This is an impediment to the implementation of fiber to the home and associated open access network architectures. Thus, there remains a need for a system and method for routing fiber optic cable to individual homes that minimizes the project cost and maximizes the bandwidth available to individual homes.

### SUMMARY OF THE INVENTION

According to an embodiment of the present invention, a local community or communities are provided access to a network served by strands of fiber that are routed in a common ribbon or cable sheath. The strands are cut, however, so that there is not a continuous optical path along a fiber strand from the beginning to the end of the cable. Instead, the cut ends of the fiber are each routed to separate customer premises. In this manner, a single cable or ribbon of fiber strands reaches twice as many customer premises. Network access is provided to customers by connecting access equipment, such as switching equipment, to the beginning and ending sides of the fiber ribbon or cable, so that network access is provided to both sides of the cut fiber strands.

The present technique of cutting optical fiber, sometimes referred to herein as a fiber breakout design, allows one to route half as many fiber cables or ribbons when building out a fiber to the home system. This results in a significant savings in construction, for example approximately a forty percent savings in the cost of fiber, to build out a fiber to the home network. The fiber breakout design facilitates providing fiber to the home networks in rural areas by making the technology more economically justified to install.

According to one embodiment of the present invention, a system for routing fiber optic signals within a geographic area includes a fiber optic cable and a communications switch. The fiber optic cable has beginning and ending sides and is routed in a loop around a geographic area to bring fiber to individual end user premises. Fibers in the loop are cut and the cut ends of the fibers are coupled to separate customer premises equipment. The communications switch is coupled to the beginning and ending sides of the fiber optic cable and a source of information, and is used to exchange information between the source of information and the customer premises equipment. The source of information may be the public switched telephone network (PSTN), a cable television network or the Internet, among other things.

According to another embodiment of the present invention, a system for routing fiber optic signals within a geographic area includes a fiber optic cable and two communications switches. The fiber optic cable has beginning and ending sides and is routed within a geographic area to bring fiber to individual end user premises. The fibers in the loop are cut and the cut ends of the fibers are coupled to separate customer premises equipment. The beginning and ending sides of the fiber optic cable are geographically removed from one another. The first communications switch is coupled to the beginning side of the fiber optic cable and a source of information, and exchanges information between the source of information and respective customer premises equipment. The second communications switch is coupled to the ending side of the fiber optic cable and exchanges information with the customer premises equipment accessible from the ending side.

The second communications switch may also be coupled to a source of information and exchange information between the source of information and respective customer premises equipment accessible from the ending side. Alternatively, the second communications switch may be coupled to the first communications switch and exchange information between respective customer premises equipment accessible from the ending side and the first communications switch.

### BRIEF DESCRIPTION OF THE FIGURES

FIG. 1 depicts a fiber to the home network having a fiber loop and breakout according to an embodiment of the present invention.

FIG. 2 depicts a fiber to the home network having a fiber line and breakout according to an embodiment of the present invention.

FIG. 3 depicts a network interface device that interacts with a fiber to the home network according to an embodiment of the present invention.

FIG. 4 depicts a fiber to the home network having a fiber line and breakout with a return fiber according to an embodiment of the present invention.

FIG. 5 depicts a fiber to the home network having an intermediate fiber cable to connect adjoining cables according to an embodiment of the present invention.

### DETAILED DESCRIPTION

According to an embodiment of the present invention, several homes (or other customer premises) are served by strands of fiber that are routed in a common ribbon or cable sheath. The strands are cut, however, so that there is not a continuous optical path along a fiber strand from the beginning to the end of the cable. Instead, the cut ends of the fiber are each routed to separate customer premises. In this manner, a single cable or ribbon of fiber strands reaches twice as many customer premises. Network access is provided to customers by connecting access equipment, such as switching equipment, to the beginning and ending sides of the fiber ribbon or cable, so that network access is provided to both sides of the cut fiber strands.

The present technique of cutting an optical fiber along its route, sometimes referred to herein as a fiber breakout design, allows one to route half as many fiber cables or ribbons when building out a fiber to the home system. This results in a significant savings in construction cost to build out a fiber to the home network. This cost savings is important, because almost forty percent of the cost of a fiber to the home network is incurred due to the cost of the fiber cables or ribbons themselves. The fiber breakout design facilitates providing fiber to the home networks in rural areas by making the technology economically justified to install.

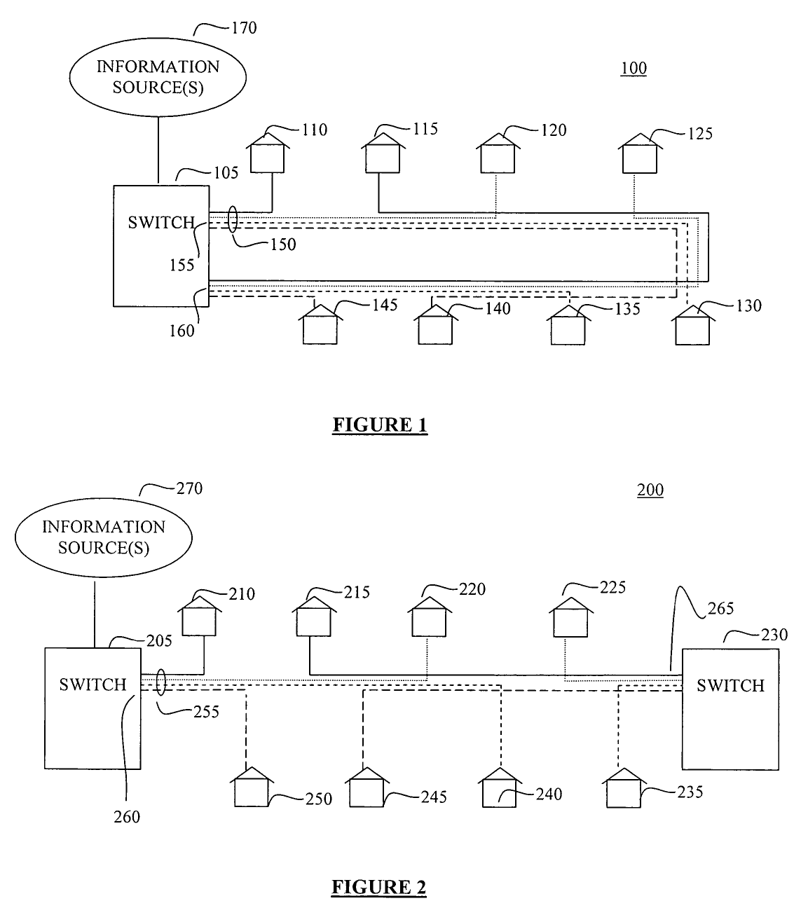

FIG. 1 depicts a fiber to the home network 100 having a fiber loop and breakout according to an embodiment of the present invention. Referring to FIG. 1, the network 100 is designed to serve, for example, a community of homes or other customer premises 110-145 spread out over a geographic area. The network 100 includes a switch 105 that is coupled between an information source 170 and one or more fiber optic cables 150.

In the embodiment depicted in FIG. 1, the fiber optic cable 150 is laid in a loop configuration so that its beginning side 155 and ending side 160 each meet at the switch 105. The fiber optic cable 150 is routed such that individual fiber strands within a bundle of fibers are cut to create two cut ends at an intermediate point along each fiber strand. The cut ends are then routed to separate respective customer premises equipment, such as a network interface device (NID), of which there is generally, though not necessarily, one per customer premises. In this manner, a single fiber optic cable with, for example, four fibers, may serve eight homes.

The information source(s) 170, which is coupled to the switch 105, may include the public switched telephone network (PSTN), a cable television network, a server, a high bandwidth link to the Internet, or a gateway or link to any other public or private network. Information is exchanged between the information source(s) and the switch 105, and is in turn exchanged between the switch 105 and respective customer premises equipment at customer premises 110-145. The switch 105 generally aggregates traffic of various types received from customers and communicates this information to the appropriate information source 170 in the upstream direction. In the downstream direction, the switch 105 receives information from the information source(s) 170 and disaggregates the information and routes it over individual fibers to the individual customer premises to which the information from the information source(s) 170 is directed. Any switch capable of high speed operation may be used to implement the switch 105. In general, the switch must include the ability to interface with the fiber optic cable 150 either directly or through an intermediate device. In a preferred embodiment, the switch is capable of interfacing either directly, or through an intermediate device or gateway, to one or more different types of information sources, such as the PSTN, cable television networks, servers, routers, links, proprietary networks or public networks. Exemplary switches include the Allied AT-9700 or AT-9400 switches available from Allied Tellison. The link between the switch 105 and the information source 170 may be established in any convenient manner by a direct electrical, wireless or optical connection, without limitation.

The switch 105 may be sized to handle particular numbers of subscribers, which are connected directly over the cable 150 to the switch 105 or connected to the switch 105 through a link to one or more other switches that are spread out over a geographic area to implement a fiber to the home network. The switch may be scalable to support growth in subscribers.

The fiber optic cable 150 is shown illustratively in FIG. 1 to include four fibers capable of servicing eight homes. It will be understood that there may be any number of fibers in a single fiber optic cable or bundle according to the present invention. In all cases, individual fiber strands within the cable are cut at strategic places along the route of the cable to effectively double the unique connection capacity of the fiber optic cable 150. The fiber optic cable may be a ribbon, loose fill fiber or any other convenient technology for bundling fiber strands together. Convenient sizes are those including 64, 84, 96 or 122 fiber strands. However, any number may be implemented in a cable according to the present invention without limitation. It will be further understood that there may be and generally are multiple fiber optic cables 150 coupled to the switch 105 for serving a local community. For any given community, the number of fiber strands or cables that are routed around the geographic area of the community being served may be chosen based on a variety of design considerations, including the number of present subscribers, the expected future subscriber growth and community growth, the need for redundant or spare fibers in case of failure of a cable or fiber strand, the need for “overhead” fibers to communicate between switches 105 when there are multiple switches around a geographic area, the cost of fiber, and other factors.

The point at which the cable 150 is cut may be done at a pedestal or other junction box. The cut ends of the cable 150 may then be coupled to separate connectors which in turn are coupled over fiber optic strands to a NID within the customer premises. There may be one or two fiber strands that couple the cut end of a fiber strand within the cable 150 to an individual subscriber. Two or more fiber strands allow some redundancy.

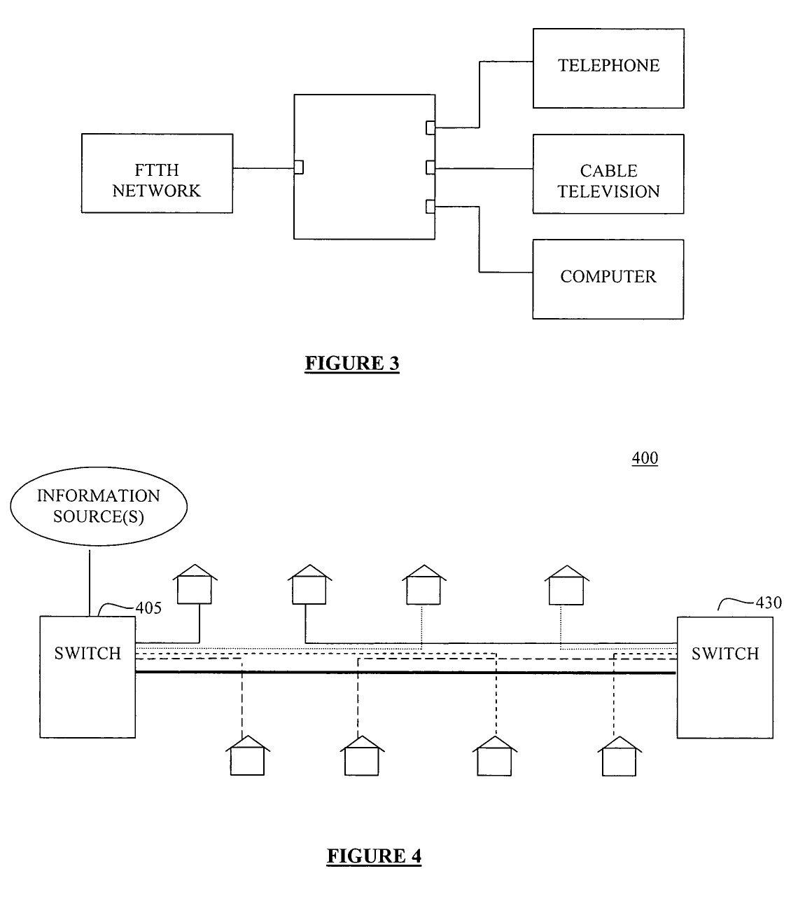

FIG. 3 depicts a NID which receives an optical fiber from a fiber to the home network and terminates the fiber inside of the customer premises. The NID may include a fiber optic port that is coupled to the fiber to the home network and one or more optical or electrical or wireless output ports implementing any convenient communications protocol. According to an embodiment of the present invention, the output ports of the NID include one or more of the following: a telephone jack, a cable television port and an Ethernet network port. Each of these ports may be illustratively coupled to a respective telephone, cable television or computer as shown to provide service to end user customers.

During operation of the fiber to the home network 100, information received from an information source 170 is transmitted over a fiber optic strand within the fiber optic cable 150 to an individual home from either the beginning side 155 or then ending side 160. The signal does not reach the other side of the cable 150. Rather, it reaches the cut end of the fiber strand at an intermediate point and is then routed to customer premises equipment. In the reverse direction, when the customer premises equipment receives or generates information and transmits that information to the cut end of a strand within the fiber optic cable 150. That information than travels to only one side of the fiber optic cable 150 to the switch 105.

FIG. 2 depicts another embodiment of the present invention for establishing a fiber to the home network for providing, for example, open network access to a rural community. The network of FIG. 2 is similar to the network of FIG. 1, in that it includes a switch 205 coupled to an information source and fiber optic cable that services multiple subscribers that includes individual fiber strands that are cut at intermediate points to provide access to subscribers. However, in the network of FIG. 2 there is an extra switch 230, coupled to an information source and the cable 150, rather than implementing a loop is routed in a straight line. The extra switch 230 may be coupled to information sources through any type of link, including direct electrical, wireless or optical. Moreover, it will be understood that the information source to which the switch 230 connects may be another switch, such as the switch 260.

In general, the network arrangement shown in FIG. 2 may be a convenient topology to implement to connect two rural communities together. The loop arrangement of FIG. 1 may be a convenient topology to implement to connect homes within a community to an open access or other network. The networks of FIG. 1 and FIG. 2 may be cascaded together, with the switches 105, 205 and 230 being capable of serving as a common switching node for adjoining an implementation of FIG. 1 and FIG. 2 together. In this manner, an entire geographic area may be served by cascading networks such as those shown in FIG. 1 and FIG. 2 together to connect communities together and homes within a community to a broadband network.

FIG. 4 depicts another embodiment of the network configuration of FIG. 2, pursuant to which an additional optical connection is established between the end switches 405 and 430. According to this embodiment, it is not necessary for the switch 430 to be coupled to a separate information source. Rather, the switch 430 is optically coupled to the switch 405 which provides access for the switch 430 to the information sources. The optical connection between the switch 430 and the switch 405 may be accomplished using one or more spare fibers within the cable 150 which are not cut along the length of the cable.

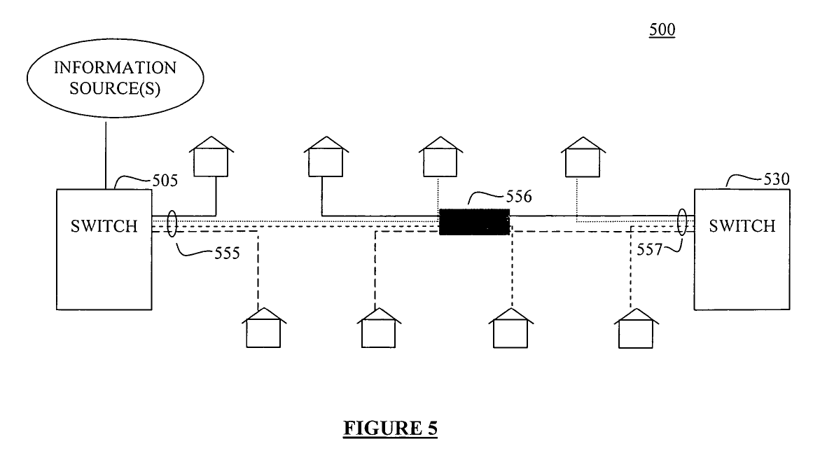

FIG. 5 depicts another implementation of the network configuration of FIG. 2 according to an embodiment of the present invention. Referring to FIG. 5, two separate fiber cables 555 and 557 serve an area. The two cables 555 and 557 are coupled together using an intermediate element 556. This allows through signals between the switches 505 and 530 and facilitates delivering signals from the cut ends of the fiber to the opposing switches 505 and 530.

The intermediate element 556 may be a fiber optic cable that interlinks fiber strands from cables 555 and 557. Alternatively, the intermediate element 556 may be an optical coupler or a switch having the same or similar characteristics to the switches 505 or 530. The intermediate element 556, when it is a switch, may also include a link to one of the switches 505 or 530 or to one or more information sources. Any of the network implementations of FIGS. 1, 2, 4 and 5 may be coupled together as shown and described to provide network coverage over a geographic area.

While particular embodiments of the present invention have been shown and described, it will be understood that changes may be made to those embodiments without departing from the spirit and scope of the present invention.

What is claimed is:

1. A system for routing fiber optic signals within a geographic area, comprising:
a fiber optic cable having beginning and ending sides, routed in a loop around a geographic area to bring fiber to individual end user premises, wherein a plurality of fibers in the loop are cut and the cut ends of the plurality of fibers are coupled to separate customer premises equipment; and
a communications switch, coupled to the beginning and ending sides of the fiber optic cable and a source of information, that exchanges information between the source of information and the customer premises equipment.

2. The system according to claim 1, wherein the source of information is the public switched telephone network.

3. The system according to claim 1, wherein the source of information is a cable television network.

4. The system according to claim 1, wherein the source of information is the Internet.

5. A system for routing fiber optic signals within a geographic area, comprising:
a fiber optic cable having beginning and ending sides and routed within a geographic area to bring fiber to individual end user premises, wherein the beginning and ending sides are geographically removed from one another, and wherein a plurality of fibers in the loop are cut and the cut ends of the plurality of fibers are coupled to separate customer premises equipment; and
a first communications switch, coupled to the beginning side of the fiber optic cable and a source of information, that exchanges information between the source of information and the customer premises equipment; and
a second communications switch, coupled to the ending side of the fiber optic cable, that exchanges information with the customer premises equipment accessible from the ending side.

6. The system according to claim 5, wherein the second communications switch is coupled to a source of information and wherein the second communications switch exchanges information between the source of information and the respective customer premises equipment accessible from the ending side.

7. The system according to claim 5, wherein the second communications switch is coupled to the first communications switch and exchanges information between the respective customer premises equipment accessible from the ending side and the first communications switch.

8. The system according to claim 5, wherein the source of information is the public switched telephone network.

9. The system according to claim 5, wherein the source of information is a cable television network.

10. The system according to claim 5, wherein the source of information is the Internet.
